(19) United States
(12) Patent Application Publication
(10) Pub. No.: US 2010/0124688 A1
(43) Pub. Date: May 20, 2010

(54) Regulator Valve for a Fluid Consuming Battery

(75) Inventors: Michael J. Brandon, II, North Ridgeville, OH (US); Chad E Law, Huron, OH (US); Paul D Griffith, JR., north olmstead, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: Eveready Battery Company, Inc.

(21) Appl. No.: 12/272,829

(22) Filed: Nov. 18, 2008

(51) Int. Cl. H01M 2/02; F16K 31/44; F16K 27/04

(52) U.S. Cl. 429/34; 251/273; 251/304

(57) ABSTRACT

A regulator is provided for supplying fluid, e.g., air, to a fluid consuming battery. The regulator includes a valve housing adapted to be in fluid communication with a fluid consuming electrode of a fluid consuming battery cell. The valve housing has an opening. The regulator also includes a valve member disposed in the opening of the housing and configured to move axial relative to the housing between an open valve position and a closed valve position, wherein fluid is able to pass to the fluid consuming electrode in the open valve position.

### BACKGROUND OF THE INVENTION

The present invention generally relates to fluid regulating systems for batteries, and more particularly relates to a regulator valve for controlling the entry of fluid, such as air, into electrochemical batteries having fluid consuming electrodes.

Electrochemical battery cells that use a fluid, such as oxygen and other gases from outside the cell as an active material to produce electrical energy, such as air-depolarized, air-assisted and fuel cell battery cells, can be used to power a variety of portable electronic devices. For example, air enters into an air-depolarized or air-assisted cell, where it can be used as, or can recharge, the positive electrode active material. The oxygen reduction electrode promotes the reaction of the oxygen with the cell electrolyte and, ultimately, the oxidation of the negative electrode active material with the oxygen. The material in the oxygen reduction electrode that promotes the reaction of oxygen with the electrolyte is often referred to as a catalyst. However, some materials used in oxygen reduction electrodes are not true catalysts because they can be at least partially reduced, particularly during periods of relatively high rate of discharge.

One type of air-depolarized cell is a zinc/air cell. This type of cell uses zinc as the negative active material and has an aqueous alkaline (e.g., KOH) electrolyte. Manganese oxides that can be used in zinc/air cells are capable of electrochemical reduction in concert with oxidation of the negative electrode active material, particularly when the rate of diffusion of oxygen into the air electrode is insufficient. These manganese oxides can then be reoxidized by the oxygen during periods of lower rate discharge or rest.

Air-assisted cells are hybrid cells that contain consumable positive and negative electrode active materials, as well as an oxygen reduction electrode. The positive electrode can sustain a high discharge rate for a significant period of time, but through the oxygen reduction electrode, oxygen can partially recharge the positive electrode during periods of lower or no discharge, so oxygen can be used for a substantial portion of the total cell discharge capacity. This generally means the amount of positive electrode active material put into the cell can be reduced and the amount of negative electrode active material can be increased to increase the total cell capacity. Examples of air-assisted cells are disclosed in commonly assigned U.S. Pat. Nos. 6,383,674 and 5,079,106.

A number of approaches have been proposed to control the amount of air entering the cells. For example, valves have been used to control the amount of air such as those disclosed in U.S. Pat. No. 6,641,947, U.S. Patent Application Publication No. 2003/0186099 and U.S. Patent Application Publication No. 2008/0085443. However, some conventional valves are typically difficult to implement with batteries and require relatively complicated electronics or external means to operate the valves.

It is therefore desirable to provide for an air manager that allows for reliable and easy control of fluid entry to a fluid consuming electrode of a fluid consuming battery.

### SUMMARY OF THE INVENTION

According to one aspect of the present invention, a fluid regulator is provided for supplying fluid to a fluid consuming battery. The regulator includes a valve housing adapted to be in fluid communication with a fluid consuming electrode of a fluid consuming battery cell. The valve housing has an opening. The regulator also includes an axially movable valve member disposed in the opening of the housing and configured to move axially relative to the valve housing between an open valve position and a closed valve position as a portion of the valve member is moved along an angled surface that is not normal to an axis of axial movement, wherein fluid is allowed to pass to a fluid consuming battery in the open valve position.

According to another aspect of the present invention, a battery is provided that includes a housing having one or more fluid entry ports for allowing passage of fluid, and a fluid consuming electrode disposed in the housing and in fluid communication with the one or more fluid entry ports. The battery also includes a valve housing in fluid communication with the fluid consuming electrode. The valve housing has an opening. The battery further includes a valve member disposed in the opening of the valve housing and configured to move axially relative to the valve housing between an open valve position and a closed valve position as a portion of the valve member is moved along an angled surface that is not normal to an axis of axial movement, wherein fluid is allowed to pass to the fluid consuming electrode in the open valve position.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a top view of a fluid consuming battery having a screw-type fluid regulator for controlling fluid entry, according to a first embodiment;

FIG. 2 is an exploded assembly view of the battery and fluid regulator of FIG. 1;

FIG. 3 is an exploded assembly view of the battery of FIG. 1, including a cross-sectional view of the fluid regulator taken through line III-III of FIG. 1;

FIG. 4 is a cross-sectional view of the fluid consuming battery having the fluid regulator in the closed valve position, taken through line IV-IV of FIG. 1;

FIG. 5 is a cross-sectional view of the fluid consuming battery shown in FIG. 1 with the fluid regulator shown with in the open valve position;

FIG. 6 is a top view of a fluid consuming battery having a screw-type fluid regulator, according to a second embodiment;

FIG. 7 is an exploded cross-sectional perspective view of the fluid regulator employed in the battery of FIG. 6;

FIG. 8 is a cross-sectional view of the battery taken through line VIII-VIII of FIG. 8 with the regulator shown in the closed valve position;

FIG. 9 is a cross-sectional view of the battery shown in FIG. 6 with the regulator shown in the open valve position;

FIG. 10 is a perspective view of a device employing a battery and a linear slide fluid regulator, according to a third embodiment;

FIG. 11 is a top view of the linear slide fluid regulator shown in FIG. 10;

FIG. 12 is a cross-sectional view taken through line XII-XII of FIG. 11 with the linear slide fluid regulator shown in the closed valve position; and

FIG. 13 is a cross-sectional view taken through line XII-XII of FIG. 11 with the slide valve fluid regulator shown in the open valve position.

### DETAILED DESCRIPTION OF THE PREFERRED EMBODIMENTS

Embodiments of this invention include a battery that includes an electrochemical cell that utilizes a fluid (such as oxygen or another gas) from outside the cell as an active material for one of the electrodes. The cell has a fluid consuming electrode, such as an oxygen reduction electrode. The cell can be an air-depolarized cell, an air-assisted cell, or a fuel cell. The battery also has a fluid regulator for adjusting the rate of passage of fluid to the fluid consuming electrode (e.g., the air electrodes in air-depolarized and air-assisted cells) to provide a sufficient amount of the fluid from outside the cell for discharge of the cell particularly at high rate or high power, while minimizing entry of fluids into the fluid consuming electrode and water gain or loss into or from the cell during periods of low rate or no discharge.

As used herein, unless otherwise indicated, the term “fluid” refers to fluid that can be consumed by the fluid consuming electrode of a fluid consuming cell in the production of electrical energy by the cell. The present invention is exemplified below by air-depolarized cells with oxygen reduction electrodes, but the invention can more generally be used in fluid consuming cells having other types of fluid consuming electrodes, such as fuel cells. Fuel cells can use a variety of gases from outside the cell housing as the active material of one or both of the cell electrodes.

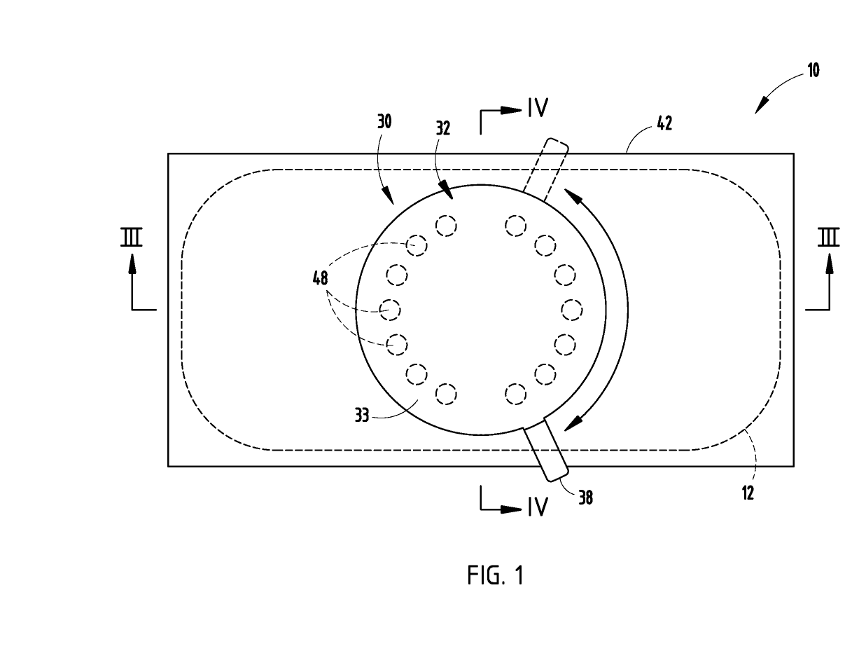

Referring now to FIGS. 1-5, a fluid consuming battery 10 is shown employing a screw-type fluid regulator 30, in accordance with a first embodiment. The fluid consuming battery 10 generally includes a fluid consuming cell 12 connected to the fluid regulator 30. The fluid regulator 30 is embodied as a screw-type valve that regulates the flow of fluid, such as air containing oxygen, to a fluid consuming electrode of the fluid consuming cell 12. The fluid regulator 30 includes a valve member 32 that is rotatable by a user to select between open and closed valve positions to control the flow of fluid (e.g., air) to the fluid consuming electrode of the battery cell 12. The fluid consuming battery 10 may be integrated within or employed separately from any of a variety of electrically powered devices, such as hearing aids, music players, flashlights and other devices to supply operating electrical power.

In the exemplary embodiment, the fluid consuming battery cell 12 is an air-depolarized cell that uses a metal active material in the form of zinc as the negative electrode active material and has an aqueous alkaline (e.g., KOH) electrolyte. The fluid consuming battery cell 12 includes an electrochemical cell that utilizes a fluid (such as oxygen or another gas) from outside the cell as an active material for one of the electrodes. The battery cell 12 has a fluid consuming electrode, such as an oxygen reduction electrode. It should be appreciated that the fluid consuming battery cell 12 may contain an air-depolarized cell, an air-assisted cell or a fuel cell, and the cell and battery may have other shapes (such as button, cylindrical, and square) and sizes, according to various embodiments.

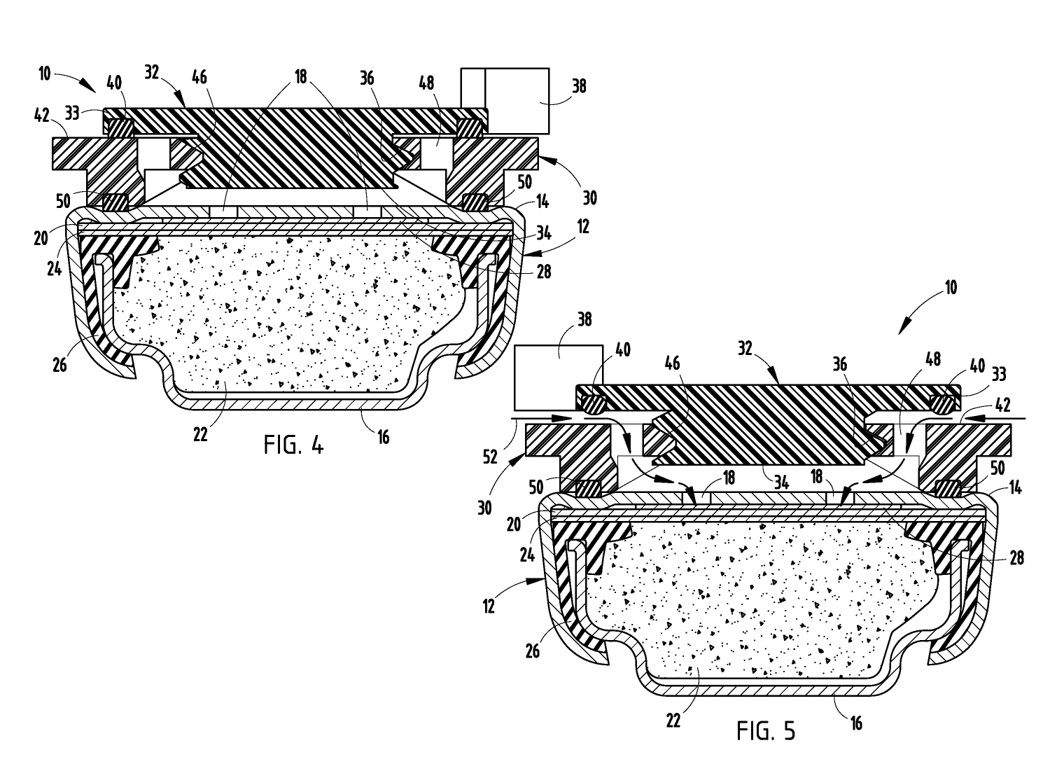

The air-depolarized cell 12 as best seen in FIGS. 4 and 5 includes a cell housing which may include a first housing component and a second housing component, which may include a can 14 and a cover 16, respectively, and may have shapes or sizes differing from what would otherwise be considered a can or cover. For purposes of example, the first housing component is hereinafter referred to the can 14, while the second housing component is hereinafter referring to as cover 16. The can 14 and cover 16 are both made of an electrically conductive material, but are electrically insulated from one another by means of a gasket 26. Can 14 generally serves as the external positive contact terminal for the fluid consuming cell 12, whereas cover 16 serves as the external negative contact terminal. The cell 12 further includes a first electrode 20, which may be the fluid consuming electrode, referred to as an air electrode in the disclosed embodiment, a second electrode 22, which may be the negative electrode (i.e., anode) and a separator 24 disposed between the first and second electrodes. The first electrode 20 is electrically coupled to can 14, whereas the second electrode 22 is electrically coupled to cover 16.

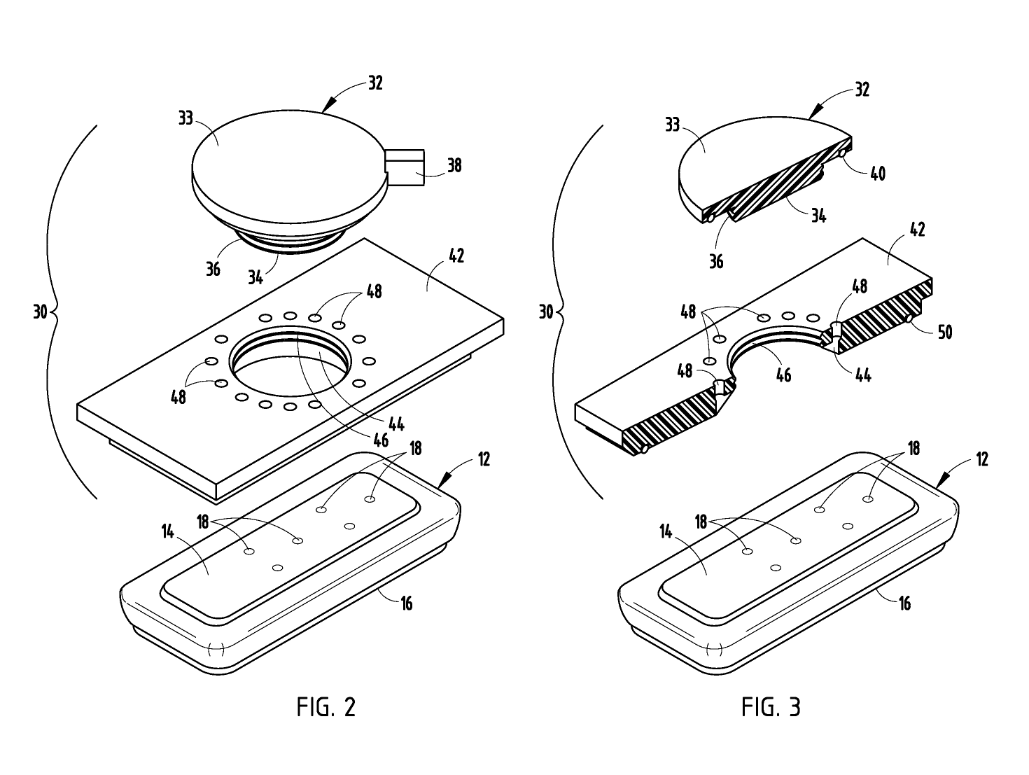

The can 14 generally includes a surface in which a plurality of fluid entry ports 18 are provided so that fluid (e.g., air) may pass to the interior of the cell housing so as to reach the fluid consuming electrode 20. In the embodiment shown in FIG. 2, the can 14 has six (6) fluid entry ports 18 provided in the top surface of can 14; however, it should be appreciated that any of a number of fluid entry ports 18 of various sizes and shapes may be employed to allow fluid to pass to the fluid consuming electrode 20 through an air distribution layer 28, which provides for more even distribution of air access across the adjacent surface for the fluid consuming electrode 20.

The fluid regulator 30 regulates the amount of fluid that may pass from the outside environment, enter through the fluid entry ports 18, and reach the fluid consuming electrode 20 of the battery cell 12. As such, the fluid regulator 30 is engaged to the exterior surface of the can 14 such that the flow of air from the outside environment to entry ports 18 is controlled by the fluid regulator 30. The fluid regulator 30 includes a valve housing shown in one embodiment as a plate 42 secured to the surface of the can 14. Valve housing 42 has a threaded opening 44 with first threads 46 provided in the walls defining opening 44. Additionally, at least one and preferably a plurality of air inlet openings 48 are formed in the valve housing 42 extending from the top surface to the bottom surface to allow fluid, such as air, to pass through the valve housing 42 when the fluid regulator 30 is in the open valve position. The fluid regulator 30 also includes a screw valve member 32 which generally includes an enlarged head 33 and a threaded screw shaft 34 having second threads 36 provided thereon. Second threads 36 are sized with a diameter and turn ratio to cooperatively engage first threads 46 within opening 44 of the plate 42, such that the valve screw member 32 may be rotated within opening 44 of valve housing 42 to open and close the fluid regulator valve.

To assist in actuating the fluid regulator 30, a lever 38 is provided on the head 33 of valve screw member 32 for easy engagement with a user's fingers. It should be appreciated that the fluid regulator 30 further includes an annular seal 40 disposed in a slot near the periphery on the bottom side of head 33 of screw member 32. The seal 40 provides a sealed closure between the screw member 32 and valve housing 42 when in the closed valve position such that fluid flow through openings 48 is prevented when the valve is in the closed valve position. Additionally, a seal 50 is provided between the battery cell can 14 and the valve housing 42 to provide sealing engagement between the valve housing 42 and the can 14.

In this embodiment, the screw-type fluid regulator 30 is operated by a user engaging lever 38 and rotating valve screw member 32 between the open and closed valve positions. The movable valve member 32 moves axially when rotated by moving along an angled surface of the first and second threads 46 and 36 that is not normal to the axis of axial movement. The angled surface also is not parallel to the axis of axial movement. In this embodiment, the surface along which the portion of the valve member is moved is a curved surface defined by the threads.

In FIG. 4, the fluid regulator 30 is shown in a fully closed valve position when the valve screw member 32 is rotated clockwise such that it is fully inserted within opening 44 so that the seal 40 provides a sealed closure against valve housing 42 to prevent fluid from passing through openings 48 between the outside environment and the battery cell 12. To open the valve of the fluid regulator 30, a user engages the lever 38 and rotates the valve screw member 32 counterclockwise such that the valve screw member 32 moves axially away from the valve housing 42 and battery cell 12 as seen in FIG. 5. When the screw member 32 is sufficiently rotated counterclockwise, the enlarged head 33 of screw member 32 and seal 40 are moved sufficiently axially away from the valve housing 42 so as to provide an unobstructed fluid flow passage 52 to allow fluid from the outside environment to pass through openings 48 and into the fluid consuming battery cell 12 by way of fluid entry ports 18, such that the fluid consuming electrode 20 receives air or other fluid. While rotational to linear translation of screw member 32 is achieved by clockwise rotation to close the valve and counterclockwise rotation to open the valve, it should be appreciated that the rotational directions may be reversed.

It should be appreciated that by rotating the screw member 32 and thereby moving the screw member 32 axially relative to the valve housing 42, the fluid regulator 30 effectively opens and closes the fluid flow passage 52 to respectively allow or prevent fluid from passing through openings 48 to the inside of the battery cell 12. When the battery 10 is not in use, a user may rotate the valve screw member 32 clockwise to move the valve screw member 32 axially toward the valve housing 42 until seal 40 closes the fluid flow passage 52 to prevent fluid from reaching the battery cell 12. Thus, it should be appreciated that an easy to use and cost effective screw-type valve fluid regulator 30 is provided for use on a battery cell 12 so as to provide for an enhanced battery construction.

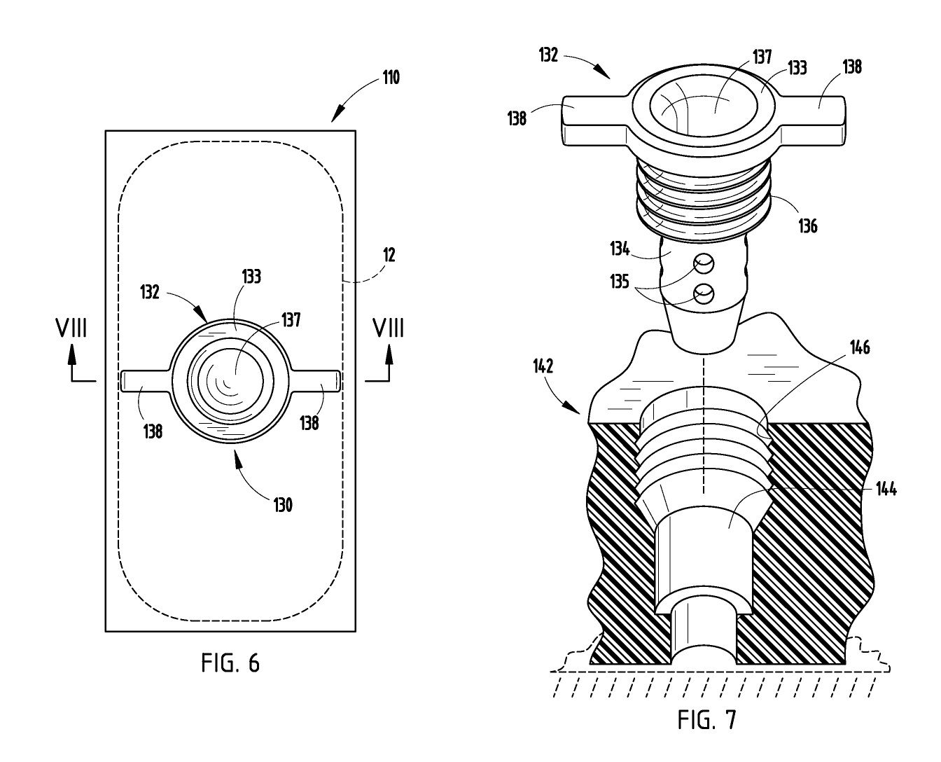

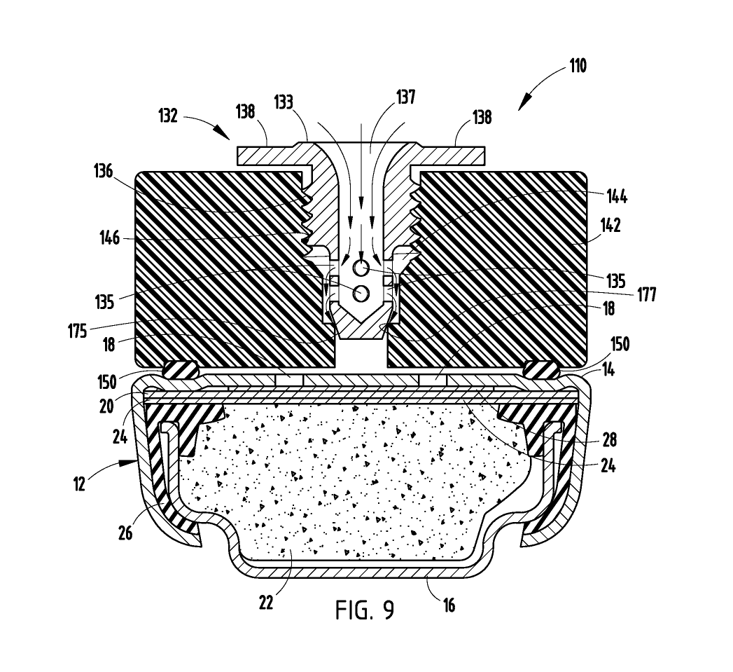

Referring to FIGS. 6-9, a fluid consuming battery 110 is illustrated having a fluid regulator 130 assembled to the fluid consuming battery 12, according to a second embodiment. The fluid regulator 130 provides a screw-type regulator valve that regulates the ingress and egress of fluid to the fluid consuming battery cell 12 based on user rotation of a valve screw member 132. In this embodiment, the screw valve member 132 is generally shown having a head portion 133 at the upper end with a pair of opposing levers 138 extending therefrom to allow a user to engage and rotate the screw member 132. The screw member 132 also has a screw portion 134 extending downward. The screw member 132 also includes a central cavity 137 extending from the top head portion 133 to a plurality of openings 135 formed in a lower side wall of the screw portion 134. The screw portion 134 also includes first threads 136 formed on the outer cylindrical wall. In this configuration, fluid is allowed to pass from the outside environment through the cavity 137 and out the openings 135 to the battery cell 12 when the fluid regulator 130 is in the open valve position.

The fluid regulating system 130 also includes a valve housing 142 shown as a plate having an opening 144 with second threads 146 formed in the side walls of the opening 144. Second threads 146 are of a size and shape configured to matingly engage first threads 136 of the screw portion 134 of screw member 132. The valve housing member 142 is sealingly engaged to the bottom side of can 14 of the battery cell 12 by way of a seal 150. It should be appreciated that the valve housing 142 may be secured or fastened to the can 14 by way of brackets, fasteners, glue or other structural connection for example.

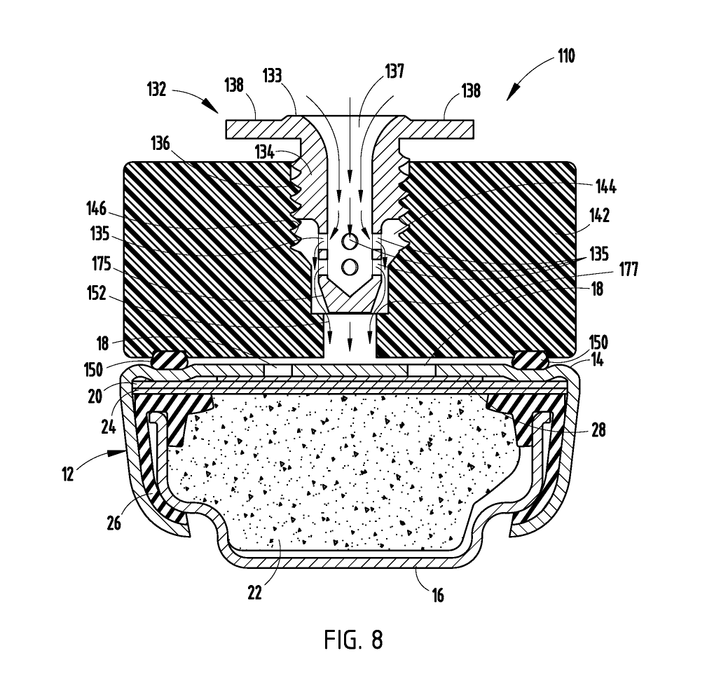

Referring to FIG. 8, the fluid regulator 130 is shown in the open valve position such that fluid (e.g., air) is able to flow from the outside environment through the cavity 137 and openings 135 such that the fluid passes through the screw member 132 into opening 144 shown by fluid flow path 152 to fluid consuming battery cell 12. The fluid passing through the valve on fluid flow path 152 then enters fluid entry ports 18 to reach the fluid consuming electrode 20 of the battery cell 12. In the open valve position, the screw member 132 is displaced axially from the plate 142 and battery cell 12 such that fluid is able to pass through the regulator valve to the battery cell 12. The movable valve member 132 moves axially when rotated by moving along an angled surface of the first and second threads 136 and 146 that is not normal to the axis of axial movement. The angled surface also is not parallel to the axis of axial movement. In this embodiment, the surface along which the portion of the valve member is moved is a curved surface defined by the threads.

To close the valve, an operator may rotate the screw member 132 by engaging levers 138 and turning screw member 132 clockwise such that the first and second threads 136 and 146 translate rotational movement of the screw member 132 axially toward the valve housing 142 and battery cell 12. Sufficient rotation of the screw member 132 will cause the angled bottom end 175 of the screw portion 134 to engage the corner 177 at the reduced diameter portion of the valve housing 142 so as to close off the air flow path 152 between the screw member 132 and valve housing 142. This movement causes the regulator valve to close, such that fluid is not able to pass into the battery cell 12. It should be appreciated that the screw member 132 may be rotationally actuated to open the regulator valve to allow air to flow to the battery cell 12 when continued operation of the battery 10 is desired.

Accordingly, the fluid consuming battery 110 employing the second embodiment of a screw-type fluid regulator 130 advantageously provides for a low cost, easy to use regulator valve for regulating the flow of fluid to a battery consuming cell 12. The fluid regulator 130 is relatively easy to use and avoids the need for complex components.

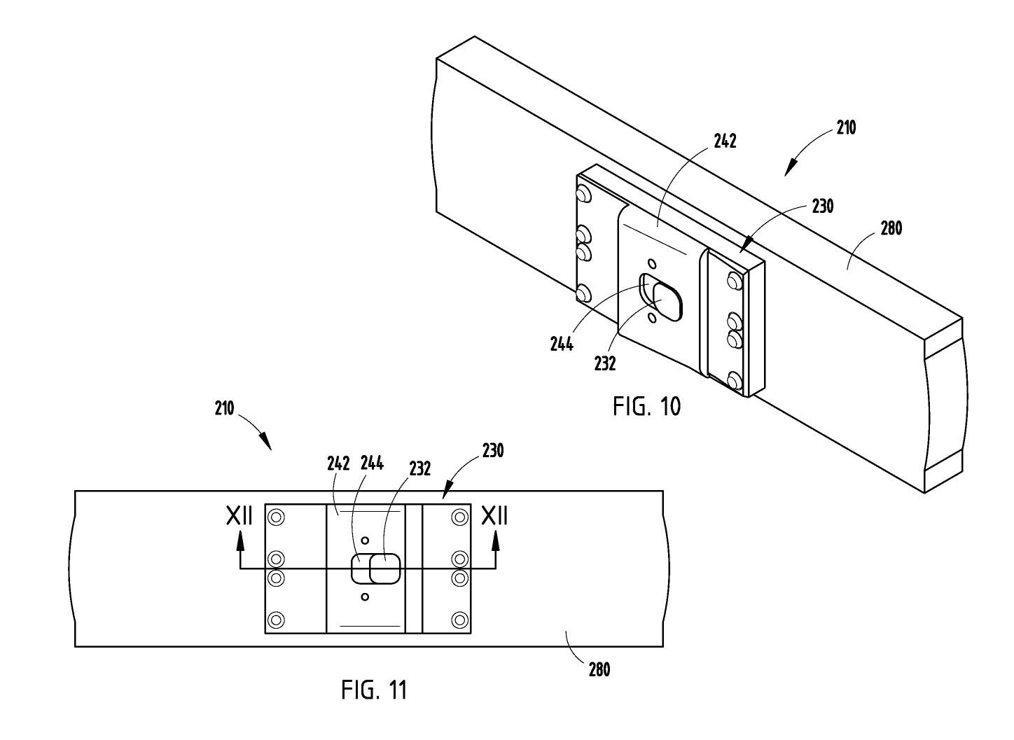

Referring to FIGS. 10-13, a device 280 is shown employing a fluid consuming battery 210 and a slide-type fluid regulator valve 230, according to a third embodiment. The fluid regulator valve 230 includes a valve housing 242 shown assembled to the device 280. The device 280 may include an electrically operated device, such as a music player, cell phone, flashlight, laptop computer, hearing aid or other electronic devices. The device 280 has a battery compartment configured having a size and shape and electrical contacts adapted to receive a fluid consuming battery, such as an air-depolarized battery cell 12 having fluid entry ports 18 and a fluid consuming electrode 20 as described above. Thus, the battery cell 12 may be disposed within the battery compartment and covered by the regulator valve housing 242.

The fluid regulator 230 in this embodiment includes a linear slide valve member 232 that is engageable and activated by a user from a closed valve position to an open valve position. The slide valve member 232 has a seal 245 that forms a sealed closure with the valve housing 242 when in the closed valve position. The slide valve member 232 follows a ramped surface on an inclined plane generally defined by an angled slot 290 formed in a side wall of the valve housing and engaged thereto with pins 292 such that the linear slide valve member 232 and seal 245 move axially away from the lower plate of valve housing 242 and battery cell 12 when sliding on the ramped surface from the closed valve position to the open valve position. In this embodiment, the slide valve 232 moves axially when slid by moving along an angled straight surface of the ramped surface that is not normal to the axis of axial movement. The ramped surface also is not parallel to the axis of axial movement.

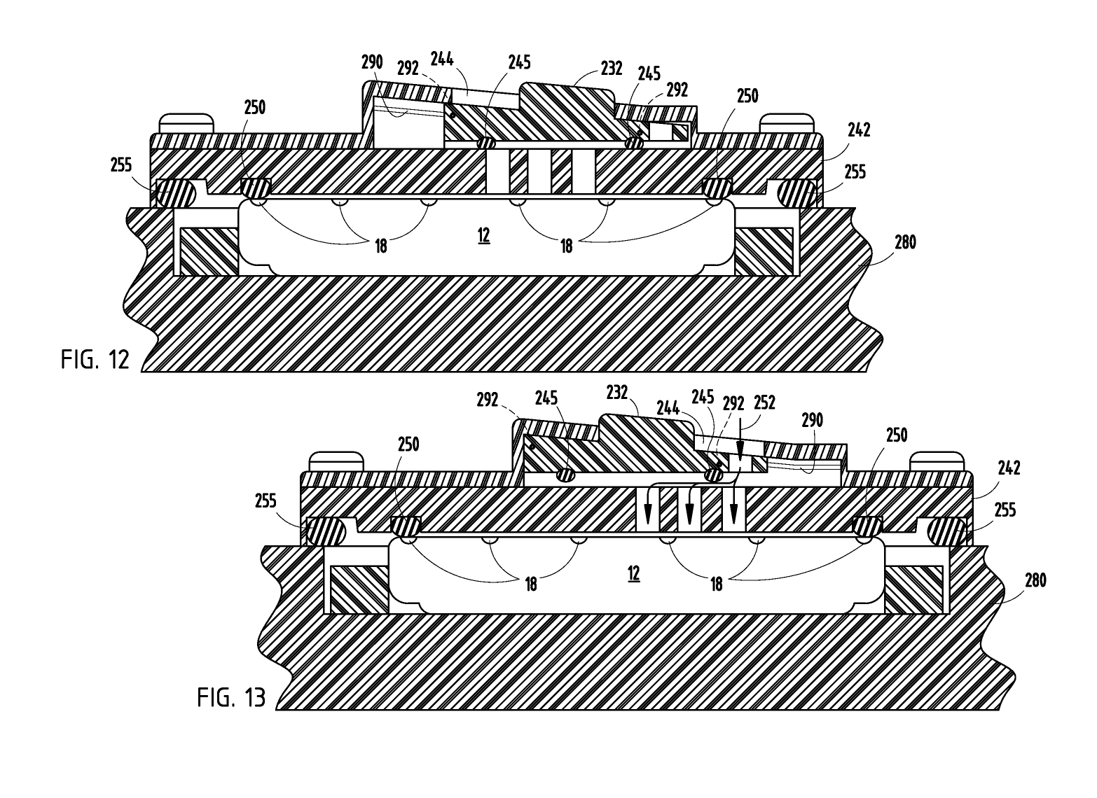

As seen in FIG. 12, the regulator valve 30 is shown in the closed valve position with the linear slide valve member 232 at the bottom of the ramped surface in the closed valve position. In this position, fluid is prohibited from flowing from the outside environment to the fluid consuming battery cell 12 due to the seal 245. To open the valve, a user engages the slide valve member 232 to move the slide valve member 232 from the bottom of the ramped surface up the ramped surface to the open position as shown in FIG. 13. In doing so, pins 292 slide in slot 290 so that the slide valve member 232 and seal 245 move axially away from plate 242 and battery cell 12 so as to provide air flow path 252 leading to fluid entry ports 18 in the battery cell 12. Accordingly, linear actuation of the slide valve member 232 translates to axial movement of the valve 232 and seal 245 to open and close the linear slide valve member. It should be appreciated that the amount of axially movement achieved with the linear movement of slide valve member 232 may depend upon the distance and the angle of the slope of the straight ramped surface. By providing a ramped surface, a small amount of linear movement may pull the slide valve member 232 and seal 245 away from the lower plate of the valve housing 242 to allow for fluid to flow through multiple paths into the fluid entry ports 18 of battery cell 12. While a pin and slot arrangement are shown for providing the ramped surface, it should be appreciated that other matingly engaged surface connections may be provided to move the slide valve member 232 axially during linear movement thereof.

The fluid regulator can be mounted directly on the cell housing, as described above, incorporated into a separate battery casing, such as the casing of a battery containing a plurality of fluid consuming cells, or incorporated into a compartment in a device in which the fluid consuming battery is installed.

In addition to a fully opened open valve position, the fluid regulator can also have one or more intermediate open valve positions in which the fluid flow is partially restricted to meet less demanding power requirements than in the fully opened open valve position.

Accordingly, the various embodiments of the screw-type and linear slide fluid regulators advantageously provide for an easy to use and cost-effective regulator valve for controlling fluid, such as air, to a fluid consuming battery cell. The fluid regulators advantageously consume a small volume, having a relatively low height, few components, few complex fabricated components, and a relatively easy to use design that is cost affordable, without the need for complex spring bias. Additionally, the fluid regulators are easily actuatable by a user manually, or may be actuated with an actuator, according to other embodiments.

While a screw-type and a linear slide embodiment of the valve regulator 30, 130 and 230 have been shown and described herein, it should be appreciated that other fluid regulators may be employed without departing from the spirit of the present invention.

While the invention has been described in detail herein in accordance with certain preferred embodiments thereof, many modifications and changes therein may be affected by those skilled in the art without departing from the spirit of the invention. Accordingly, it is our intent to be limited only by the scope of the appending claims and not by way of the details and instrumentalities describing the embodiments shown herein.

What is claimed is:

1. A fluid regulator for supplying fluid to a fluid consuming battery, said regulator comprising:
a valve housing adapted to be in fluid communication with a fluid consuming electrode of a fluid consuming battery cell, said valve housing having an opening; and
a movable valve member disposed in the opening of the housing and configured to move axially relative to the valve housing between an open valve position and a closed valve position as a portion of the valve member is moved along an angled surface that is not normal to an axis of axial movement, wherein fluid is allowed to pass to the fluid consuming battery in the open valve position.

2. The regulator as defined in claim 1, wherein the surface along which the portion of the valve member is moved is a curved surface.

3. The regulator as defined in claim 2, wherein the valve member comprises a screw valve member having first threads that engage second threads provided in the housing such that the screw valve member is rotated to move axially relative to the housing.

4. The regulator as defined in claim 3, wherein the screw valve member further comprises a fluid passage that allows fluid to flow into the housing when the screw valve member is in the open valve position.

5. The regulator as defined in claim 3, wherein the screw valve member has a fluid flow passage within the screw valve member.

6. The regulator as defined in claim 3, wherein the housing comprises one or more holes extending therethrough, wherein the screw valve member covers the holes in the closed valve position.

7. The regulator as defined in claim 1, wherein the surface along which the portion of the valve member is moved is a straight surface.

8. The regulator as defined in claim 7, wherein the valve member comprises a ramp valve that slides linearly on a ramped surface to move the valve member axially relative to the housing.

9. The regulator as defined in claim 1, wherein the fluid regulator supplies air to an air consuming cell.

10. A battery comprising:
a housing having one or more fluid entry ports for allowing for the passage of fluid;
a fluid consuming electrode disposed in the housing and in fluid communication with the one or more fluid entry ports;
a valve housing in fluid communication with the fluid consuming electrode, said valve housing having an opening; and
a valve member disposed in the opening of the valve housing and configured to move axially relative to the valve housing between an open valve position and a closed valve position as a portion of the valve member is moved along an angled surface that is not normal to an axis of axial movement, wherein fluid is allowed to pass to the fluid consuming electrode in the open valve position.

11. The battery as defined in claim 10, wherein the surface along which the portion of the valve member is moved is a curved surface.

12. The battery as defined in claim 11, wherein the valve member comprises a screw valve member having first threads that engage second threads provided in the housing such that the screw valve member is rotated to move axially relative to the housing.

13. The battery as defined in claim 12, wherein the screw valve member further comprises a fluid passage that allows fluid to flow into the valve housing when the screw member is in the open valve position.

14. The battery as defined in claim 12, wherein the screw valve member has a fluid flow passage within the screw valve member.

15. The battery as defined in claim 12, wherein the valve housing comprises one or more holes extending therethrough, wherein the screw valve member covers the holes in the closed valve position.

16. The battery as defined in claim 10, wherein the surface along which the portion of the valve member is moved is a straight surface.

17. The battery as defined in claim 16, wherein the valve member comprises a ramp valve that slides on a ramped surface to move the valve axially relative to the valve housing.

18. The battery as defined in claim 10, wherein the fluid consuming electrode comprises an air consuming electrode.

19. The battery as defined in claim 18, wherein the battery comprises an aqueous alkaline electrolyte and a second electrode comprising a metal active material.

20. The battery as defined in claim 19, wherein the second electrode comprises zinc.
